(19) United States
(12) Patent Application Publication
(10) Pub. No.: US 2016/0088546 A1
(43) Pub. Date: Mar. 24, 2016

(54) REGULATION VIA GEOFENCE BOUNDARY SEGMENT CROSSINGS

(71) Applicant: Intel Corporation, Santa Clara, CA (US)

(72) Inventors: Thomas A. Birch, Portland, OR (US); Derick A. Johnson, Folsom, CA (US); Paul Donohue, Dublin (IE)

(21) Appl. No.: 14/490,920

(22) Filed: Sep. 19, 2014

(51) Int. Cl. H04W 48/04; H04W 4/02

(52) U.S. Cl. CPC H04W 48/04; H04W 4/021

(57) ABSTRACT

Embodiments related to regulating access to content via geofence boundary segment crossings are disclosed herein. For example, in some embodiments, a computing system for regulating access to content may include: boundary segment crossing logic to determine whether a mobile computing device satisfies boundary segment crossing criteria, wherein the boundary segment crossing criteria includes that the mobile computing device crossed a predetermined segment of a geofence boundary into an area defined by the geofence boundary; and/or content access logic, coupled to the boundary segment crossing logic, to, in response to a determination by the boundary segment crossing logic that the mobile computing device satisfied the boundary segment crossing criteria, provide a content identifier, associated with the predetermined segment of the geofence boundary, to the mobile computing device. Other embodiments may be disclosed and/or claimed.

### TECHNICAL FIELD

The present disclosure relates generally to the field of geofencing, and more particularly, to regulation via geofence boundary segment crossings.

### BACKGROUND

Geofence functionality is implemented in a number of mobile computing device applications to detect whether a mobile computing device is within a geofence boundary. However, conventional geofence applications have typically been limited to binary “within/without” decision-making.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an illustrative computing system configured for regulating access to content via geofence boundary segment crossings, in accordance with various embodiments.

FIG. 2 is a block diagram of an illustrative content access regulation system that may be implemented by the computing system of FIG. 1, in accordance with various embodiments.

FIG. 3 is a map view of an illustrative geofence boundary, in accordance with various embodiments.

FIGS. 4-6 are map views of illustrative boundary segments of the illustrative geofence boundary of FIG. 3, in accordance with various embodiments.

FIGS. 7-8 depict illustrative content displays that may be provided to a mobile computing device when different boundary segment crossing criteria are satisfied, in accordance with various embodiments.

FIG. 9 is a map view of various mobile computing device trajectories through and around the illustrative geofence boundary of FIG. 3, in accordance with various embodiments.

FIG. 10 illustrates an example data structure that may be used to store geofence, boundary segment, and content identifier data, in accordance with various embodiments.

FIG. 11 illustrates an example data structure that may be used to store mobile computing device data for regulating access to content via geofence boundary segment crossings, in accordance with various embodiments.

FIG. 12 is a flow diagram of a method for regulating access to content via geofence boundary segment crossings, in accordance with various embodiments.

### DETAILED DESCRIPTION

Embodiments related to regulating access to content via geofence boundary segment crossings are disclosed herein. For example, in some embodiments, a computing system for regulating access to content may include: boundary segment crossing logic to determine whether a mobile computing device satisfies boundary segment crossing criteria, wherein the boundary segment crossing criteria includes that the mobile computing device crossed a predetermined segment of a geofence boundary into an area defined by the geofence boundary, wherein the predetermined segment of the geofence boundary represents less than an entirety of the geofence boundary; and/or content access logic, coupled to the boundary segment crossing logic, to, in response to a determination by the boundary segment crossing logic that the mobile computing device satisfied the boundary segment crossing criteria, provide a content identifier, associated with the predetermined segment of the geofence boundary, to the mobile computing device.

Conventional geofence technologies may recognize the difference between a computing device located within a geofence and a computing device located outside a geofence, but have not considered the significance of the trajectory with which the computing device crossed into the geofence. As an example of a current approach using conventional geofence technology, a computing device located within the geofence corresponding to a manufacturing facility may be granted access to a manufacturing schedule system and maps of the facility even if a user snuck the computing device into the manufacturing facility through a window or other unauthorized point of entry (rather than going through a regulated security gate).

Various ones of the embodiments disclosed herein may provide mobile computing devices with access to content when the mobile computing devices have crossed into a geofenced area through a designated segment of the geofence boundary (e.g., the front doors or security gate). Crossings at other locations may not enable the mobile computing device to access the same (or any) content. In some embodiments, coming into a geofenced area through different entrances may enable the mobile computing device to access different content. For example, if a user enters a performance venue through the VIP line, free drink tickets, a backstage pass, a parking permit, or other amenities may be pushed or otherwise made available to the user's mobile computing device. A user that enters the same performance venue through a general admission line, however, may receive or be able to access less valuable content on his or her mobile computing device (or no particular content at all).

In some embodiments, the predetermined segments of a geofence boundary (e.g., a polygonal geofence boundary) may serve as “activation lines” for the geofence in the sense that only when the trajectory of a mobile computing device crosses one of the predetermined segments will content associated with the geofence be made available. Thus, being located within a geofence may be only one part (or no part) of the content access determination; the path via which the mobile computing device entered the geofence is relevant.

The systems and techniques disclosed herein may enable facilities to improve their security by requiring that mobile computing devices entering the facility pass through designated areas (e.g., security checkpoints) before the mobile computing device may access content associated with the facility. The systems and techniques disclosed herein may be nested so that multiple different content identifiers, provided to a mobile computing device upon crossing each of multiple different boundary segments, are required in order for the mobile computing device to access content (and fewer than the required number and type of content identifiers may not be sufficient).

Additionally, although various embodiments are described herein in which a mobile device is granted access to content when the mobile device itself satisfies geofence boundary crossing criteria, other devices associated with the mobile device (e.g., via a common user) may be granted access to content instead of or in addition to the mobile device itself when the mobile device satisfies boundary crossing criteria. In some such embodiments, the mobile device may serve as the “triggering” device that allows some or all additional devices associated with a common user to access content (e.g., by giving the user access to the content). For example, if a user's smartphone crosses a geofence boundary in a manner that satisfies boundary crossing criteria for access to a website, the user herself may be given access to the website so that the user may access the website from her laptop instead of or in addition to her smartphone.

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description uses the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. As used herein, the phrase “coupled” may mean that two or more elements are in direct physical or electrical contact, or that two or more elements are not in direct contact with each other, but yet still cooperate or interact with each other (e.g., via one or more intermediate elements, which may perform their own transformations or have their own effects). For example, two elements may be coupled to each other when both elements communicate with a common element (e.g., a memory device). As used herein, the term “logic” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality. As used herein, a signal may be “received” by a component if it is generated externally or internally to that component, and acknowledged and/or processed by that component.

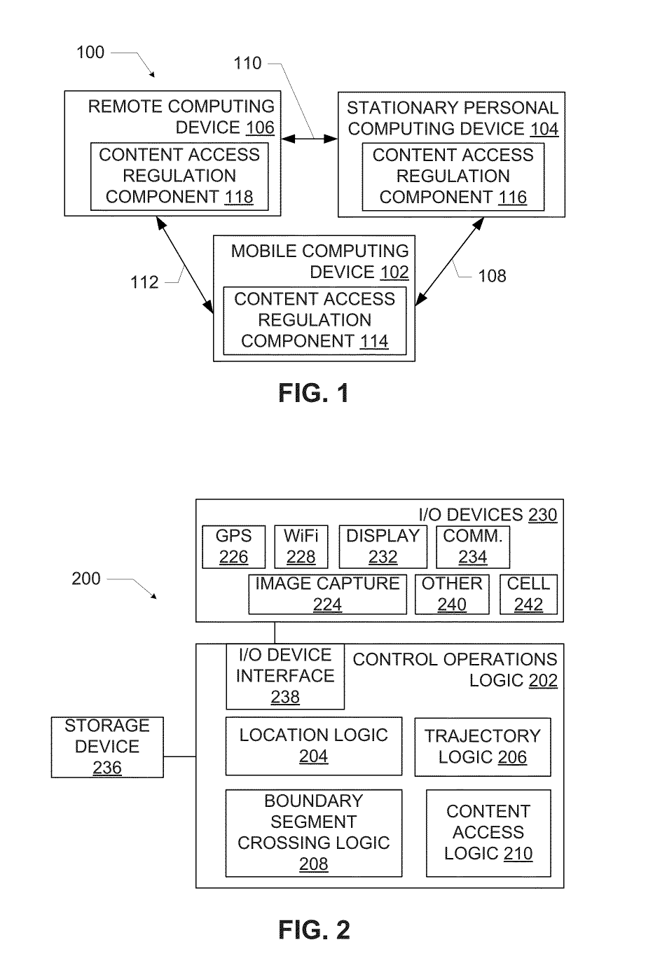

FIG. 1 depicts an illustrative computing system 100 configured for regulating access to content via geofence boundary segment crossings, in accordance with various embodiments. In some embodiments, the computing system 100 may be configured to determine whether a mobile computing device satisfies boundary segment crossing criteria. The boundary segment crossing criteria may include that the mobile computing device crossed a predetermined segment of a geofence boundary into an area defined by the geofence boundary. The predetermined segment of the geofence boundary may represent less than the entire geofence boundary. The predetermined segment may correspond to a geographic location of a particular entrance to a building or other area (e.g., to a geographic location of a door, loading dock, entry point to an airport security queue, or other entryway). In response to a determination by the computing system 100 that the mobile computing device satisfied the boundary segment crossing criteria, the computing system 100 may also be configured to provide a content identifier, associated with the predetermined segment of the geofence boundary, to the mobile computing device. In some embodiments, the computing system 100 may include hardware configured to generate information about the location of the mobile computing device (e.g., Global Positioning System (GPS) and/or WiFi-based location devices) and hardware to control the operation of the computing system 100 based on the trajectory of the mobile computing device relative to the predetermined segments (e.g., a monitor or audio system for displaying content associated with the content identifier).

The computing system 100 may include a mobile computing device 102, a stationary personal computing device 104, and a remote computing device 106. Each of the mobile computing device 102, the stationary personal computing device 104, and the remote computing device 106 may include content access regulation components (illustrated in FIG. 1 as content access regulation components 114, 116, and 118, respectively). Content access regulation operations, I/O hardware and logic (e.g., any of the operations and logic discussed below with reference to the content access regulation system 200) may be distributed between the content access regulation components 114, 116, and 118 of the computing system 100 as suitable. Several examples of the distribution of operations between the components of the computing system 100 are discussed herein, but any other combination of more or less components and distribution of the operations may be used. In some embodiments, the computing system 100 may be configured as the content access regulation system 200, discussed below with reference to FIG. 2.

Communication within the computing system 100 may be enabled by the communication pathways 108, 110, and 112. The communication pathways 108, 110, and 112 may each include wired communication pathways and/or wireless communication pathways, over direct couplings, and/or over personal, local, and/or wide area networks. Each of the mobile computing device 102, the stationary personal computing device 104, and the remote computing device 106 may include suitable hardware for supporting the communication pathways 108, 110, and 112, such as network interface cards, modems, WiFi devices, Bluetooth devices, and so forth. In some embodiments, the communication pathways 108, 110, and 112 may be direct communication pathways between the components as illustrated in FIG. 1. As used herein, references to “direct” communication pathways between two components of the computing system 100 of FIG. 1 (or any system or device disclosed herein) may refer to a communication pathway that does not route through another illustrated component, but that may route through other non-illustrated devices (e.g., routers and/or switches). Each of the computing devices included in the computing system 100 may include a processing device and a storage device (not shown). The processing device may include one or more processing devices, such as one or more processing cores, ASICs, electronic circuits, processors (shared, dedicated, or group), combinational logic circuits, and/or other suitable components that may be configured to process electronic data. The storage device may include any suitable memory or mass storage devices (such as solid-state drive, diskette, hard drive, compact disc read only memory (CD-ROM), and so forth). Each of the computing devices included in the computing system 100 may include one or more buses (and bus bridges, if suitable) to communicatively couple the processing device, the storage device, and any other devices included in the respective computing devices.

The storage device may include a set of computational logic, which may include one or more copies of computer readable media (e.g., non-transitory computer readable media) having instructions stored therein that, when executed by the processing device of the computing device, may cause the computing device to implement any of the techniques and methods disclosed herein, or any portion thereof.

The mobile computing device 102, the stationary personal computing device 104, and the remote computing device 106 may each include peripheral devices, which may communicate via wired or wireless communication pathways, such as cameras, printers, scanners, radio frequency identification (RFID), readers, credit card swipe devices, or any other peripheral devices. Except for the geofence boundary segment crossing-based content access regulation teachings of the present disclosure incorporated therein, the mobile computing device 102, the stationary personal computing device 104, and the remote computing device 106 may be a broad range of such devices known in the art. Specific, but not limiting, examples are described below. In some embodiments, the computational logic may include any of the logic discussed below with reference to FIG. 2.

The mobile computing device 102 may be a computing device that is configured for carrying along with a user. In some embodiments, the mobile computing device 102 may be a wearable computing device, and may be integrated into a garment, accessory, or other support structure that is configured to be worn on the body of the user (or “wearer”). Examples of suitable support structures for the mobile computing device 102 may include glasses, a headset, a hair accessory (e.g., a headband or barrette), an ear piece, jewelry (e.g., a brooch, earrings, or a necklace), a wrist band (e.g., a wristwatch), a neck band (e.g., a tie or scarf), a garment (e.g., a shirt, pants, a dress, a skirt, or a jacket), a hat, shoes, a lanyard or name tag, a contact lens, or an implantable support structure, among others. In some embodiments, the mobile computing device 102 may include one or more devices for generating data about the location and/or velocity of the mobile computing device 102, such as a GPS device, a WiFi-based location device, a cellular network-based location device, an image capture device for capturing images of the environment of the mobile computing device 102, an accelerometer, an altimeter, or any other such device. The mobile computing device 102 may also include a communications device for wired and/or wireless transmission of the location and/or velocity data to other computing devices (e.g., the stationary personal computing device 104 and the remote computing device 106).

In some embodiments, the mobile computing device 102 may be a computing device configured for carrying in a pocket, backpack, or other carrying case. Examples of mobile computing devices that may serve as the mobile computing device 102 include cellular phones, smartphones, other personal mobile communication devices, tablets, electronic book readers, personal digital assistants, laptops, or other such computing devices. Content access regulation and other operations performed by the mobile computing device 102 may be controlled by an app or plug-in on the mobile computing device 102, for example. Although the mobile computing device 102 may be referred to in the singular, the mobile computing device 102 may include two or more distinct devices associated with the user. For example, the mobile computing device 102 may include a wrist-mounted computing device in communication with a smartphone. Processing operations performed by the mobile computing device 102 in this example may be distributed between the wrist-mounted computing device and the smartphone.

In some embodiments, the stationary personal computing device 104 may be a computing device configured to rest semi-permanently on a surface (e.g., as a server does in a rack or a desktop computer does on a desk). Examples of personal computing devices that may serve as the stationary personal computing device 104 include desktop computing devices, point-of-sale terminals, terminals located at a security desk in a facility, and large shared computing kiosks. Content access regulation and other operations performed by the stationary personal computing device 104 may be controlled by an application or plug-in on the stationary personal computing device 104, for example. In some embodiments, the stationary personal computing device 104 or the remote computing device 106 may have more computing resources (e.g., processing power, memory, and/or communication bandwidth) than the mobile computing device 102. Thus, in some embodiments, data captured and preliminarily processed by the mobile computing device 102 may be transmitted over the communication pathway 108 to the stationary personal computing device 104, or over the communication pathway 112 to the remote computing device 106, for further processing.

The remote computing device 106 may include one or more servers (e.g., arranged in a “cloud” computing configuration) or other computing devices remote from the mobile computing device 102 and the stationary personal computing device 104. The communication pathway 112 between the mobile computing device 102 and the remote computing device 106, and the communication pathway 110 between the stationary personal computing device 104 and the remote computing device 106, may be configured according to any remote wired or wireless communication protocol. In some embodiments, the remote computing device 106 may have more computing resources (e.g., processing power, memory, and/or communication bandwidth) than the mobile computing device 102 or the stationary personal computing device 104. Thus, in some embodiments, data captured and preliminarily processed by the mobile computing device 102 and/or the stationary personal computing device 104 may be transmitted over the communication pathways 110 and/or 112 to the remote computing device 106 for further processing. In some embodiments, the remote computing device 106 may perform most of the content access regulation operations discussed below with reference to FIG. 2, including those performed by the boundary segment crossing logic 208 and/or the content access logic 210, for example.

In some embodiments, the remote computing device 106 may communicate with a plurality of stationary personal computing devices (configured similarly to the stationary personal computing device 104) and/or a plurality of mobile computing devices (configured similarly to the mobile computing device 102). The remote computing device 106 may perform similar processing and storage operations for each mobile or stationary personal computing device. For example, the remote computing device 106 may receive location signals provided by a plurality of mobile computing devices (configured similarly to the mobile computing device 102) and may perform content access regulation operations based on the location signals (e.g., determining whether the mobile computing device satisfies boundary segment crossing criteria as discussed below with reference to the boundary segment crossing logic 208, and/or providing content identifiers as discussed below with reference to the content access logic 210). The remote computing device 106 may devote different resources to different ones of the plurality of personal or wearable computing devices in communication with the remote computing device (e.g., different memory partitions or databases for each device).

In some embodiments of the content access regulation systems disclosed herein, one or more of the components of the computing system 100 shown in FIG. 1 may not be included. For example, in some embodiments, the computing system 100 may not include a remote computing device 106. In some embodiments, the computing system 100 may not include a stationary personal computing device 104, and all content access regulation operations may be distributed between the mobile computing device 102 and the remote computing device 106. In some embodiments, one or more of the communication pathways between components of the computing system 100 may not be included; for example, in some embodiments, the mobile computing device 102 may not communicate directly with the remote computing device 106 via the communication pathway 112 (but may communicate with the remote computing device 106 via the stationary personal computing device 104 and the communication pathways 108 and 110).

FIG. 2 depicts an illustrative content access regulation system 200, in accordance with various embodiments. As discussed above with reference to the computing system 100, the content access regulation system 200 may be configured to perform any of a number of geofence boundary segment crossing-based content access regulation operations. For example, the content access regulation system 200 may be configured to determine whether a mobile computing device satisfies boundary segment crossing criteria. The boundary segment crossing criteria may include that the mobile computing device crossed a predetermined segment of a geofence boundary into an area defined by the geofence boundary. The predetermined segment of the geofence boundary may represent less than the entire geofence boundary. In response to a determination by the content access regulation system 200 that the mobile computing device satisfied the boundary segment crossing criteria, the content access regulation system 200 may also be configured to provide a content identifier, associated with the predetermined segment of the geofence boundary, to the mobile computing device.

The content access regulation system 200 may be implemented by the computing system 100 of FIG. 1, in accordance with various embodiments. For example, the logic and hardware (e.g., I/O hardware) included in the content access regulation system 200 may distributed in any suitable manner between the mobile computing device 102, the stationary personal computing device 104, and the remote computing device 106 (e.g., in the content access regulation components 114, 116, and 118, respectively). In particular, when the content access regulation system 200 determines whether a mobile computing device satisfies boundary segment crossing criteria and provides a content identifier to the mobile computing device (as discussed in the preceding paragraph), that mobile computing device may be the mobile computing device 102.

The components of the content access regulation system 200 may be distributed in any suitable manner among one or more of the content access regulation components 114, 116, and 118 of the computing system 100. For example, in some embodiments, the boundary segment crossing logic 208 and the content access logic 210 may be included in the content access regulation component 114 of the mobile computing device 102. In some embodiments, the location logic 204 may be included in the content access regulation component 114 of the mobile computing device 102, and the boundary segment crossing logic 208 and the content access logic 210 may be included in the content access regulation component 116 of the personal computing device 104 and/or the content access regulation component 118 of the remote computing device 106. In some embodiments, the boundary segment crossing logic 208 and the content access logic 210 may be included in different content access regulation components of the content regulation access components 114-118. In some embodiments, all of the control operations logic 202 of the content access regulation system 200 may be included in the content access regulation component 114 of the mobile computing device 102. In some embodiments, none of the control operations logic 202 of the content access regulation system 200 may be included in the content access regulation component 114 of the mobile computing device 102, and may instead be distributed in any desired manner between the content access regulation component 116 of the personal computing device 104 and the content access regulation component 118 of the remote computing device 106.

Although a number of components are illustrated in FIG. 2, various embodiments may omit components as appropriate for the geofence crossing control operations to be performed. For example, some embodiments of the content access regulation system 200 may not be configured for WiFi location determination (and instead may use another location determination technique, or receive a location signal from an external device), and thus may not include the WiFi device 228.

The content access regulation system 200 may include input/output (I/O) devices 230. The I/O devices 230 may include an image capture device 224, a GPS device 226, a WiFi device 228, a display 232, a communication device 234, and/or other I/O devices 240. Although the I/O devices 230 (and other components described herein) may be referred to in the plural, any number of I/O devices may be included in the I/O devices 230 (and similarly, any component may include multiple such components).

In some embodiments, the image capture device 224 may include one or more digital cameras, for example, and may use any imaging wavelength (e.g., visible or infrared light). Images captured by the image capture device 224 may be used to generate a location signal indicative of a location or a range of locations of the mobile computing device 102. In some embodiments, images captured by the image capture device 224 may be used to generate a velocity signal indicative of a speed and direction in which the mobile computing device 102 is moving. For example, images captured by the image capture device 224 of the environment of the mobile computing device 102 may be transmitted to the location logic 204 (discussed below), and the location logic 204 may compare the captured images to images stored in the storage device 236 to identify recognized landmarks, in accordance with known techniques. When landmarks in the environment are identified in the captured images, the location logic 204 may determine an approximate location of the mobile computing device 102, and may generate a location signal accordingly. In some embodiments, the trajectory logic 206 may compare multiple images captured by the image capture device 224 of the environment of the mobile computing device 102 to determine the speed at which the mobile computing device 102 is moving (e.g., by dividing the distance traveled between successive images by the time delay between the capture of the successive images). The trajectory logic 206 may determine a direction of motion of the mobile computing device 102 by comparing multiple images captured by the image capture device 224 of the environment of the mobile computing device 102 to images stored in the storage device 236; identifying common landmarks between the captured and stored images may allow the trajectory logic 206 to identify a direction of motion. In other embodiments, the trajectory logic 206 may not determine a speed of motion, but may instead receive location signals from the location logic 204 and may determine a trajectory based on multiple locations of the mobile computing device 102.

As used herein, the term “camera” may include still image cameras and video cameras. In some embodiments, the image capture device 224 may capture video, such as high-definition video. In some embodiments, the image capture device 224 may be configured to stream image data (e.g., video data) to other devices via a wired or wireless communication pathway. For example, the image capture device 224 may be included in the mobile computing device 102 (FIG. 1), and may stream image data wirelessly to the stationary personal computing device 104 via the communication pathway 108. In some embodiments, the image capture device 224 may be integral or peripheral to the stationary personal computing device 104, and may provide streamed image data. In some embodiments, the image capture device 224 may include a visible light camera and an infrared camera, and may combine the images captured by these devices or treat them separately. In some embodiments, the image capture device 224 may include two or more cameras having different orientations (e.g., one camera that is mounted on, or otherwise associated with, the mobile computing device 102 and faces the front of a user's body, and one camera that is mounted on the mobile computing device 102 and faces away from the user but may include the user's arms and hands as they gesture in front of the user). In some embodiments, the image capture device 224 may capture a sequence of successive images. These successive images may be captured at a rate of multiple frames per second, or faster or slower.

In some embodiments, the image capture device 224 may include a depth camera (which may also be referred to as a “three-dimensional camera”). Images produced by a depth camera may include depth data per pixel. The depth data for a pixel may be a value that represents the distance between an object in an imaged scene corresponding to the pixel, and the image capture device 224. A depth camera may include a depth image sensor, an optical lens, and an illumination source, among other components. The depth image sensor may rely on any of a number of different sensor technologies, such as time-of-flight (TOF) technology (e.g., scanning TOF or array TOF), structured light, laser speckle pattern technology, stereoscopic cameras, active stereoscopic sensors, and shape-from-shading technology, for example. Many depth camera sensor technologies include “active” sensors, which supply their own illumination source. Other depth camera sensor technologies (e.g., stereoscopic cameras) may include “passive” sensors, which do not supply their own illumination source but depend instead on ambient environmental lighting. In addition to depth data, depth cameras may also generate color data, in the same way that conventional color cameras do, and this color data may be combined with the depth data during processing of depth camera images. In some embodiments, depth data may be used by the location logic 204 to establish the distance between a recognized landmark and the mobile computing device 102 in which the depth camera is mounted or to which the depth camera is proximate, and thereby establish a location or a range of locations in which the mobile computing device 102 is located.

The GPS device 226 may be configured to receive messages from satellites that allow the GPS device 226 to generate location data for a device in which the GPS device 226 is included, in accordance with known techniques. The location data may include latitude, longitude, and altitude, for example. In some embodiments, the GPS device 226 may be included in the mobile computing device 102.

The WiFi device 228 may be configured to generate location data for a device in which the WiFi device 228 is located based on the received signal strengths from identified WiFi beacons (e.g., identified via Service Set Identifiers and/or Media Access Control data) having known positions (e.g., stored in the storage device 236 or another accessible storage device), in accordance with known techniques. In some embodiments, the WiFi device may be included in the mobile computing device 102.

The cellular location device 242 may be configured to generate location data based on multilateration of cellular communication network signals from different radio towers detected at a device in which the cellular location device 242 is located, in accordance with known techniques. In some embodiments, the cellular location device 242 may be included in the mobile computing device 102.

Any other device for location/velocity data generation may be included in the other I/O devices 240, including an accelerometer (whose signal may be integrated once to generate velocity data and twice to generate location data), an altimeter, an Internet Protocol (IP) address detection device, a proximity sensor (e.g., used by the mobile computing device 102 to detect proximity to a beacon deployed at a desired location), or any other suitable device. The other I/O devices 240 may also include devices that serve functions other than location/velocity determination, such as a keyboard, a cursor control device such as a mouse, a stylus, a touchpad, a bar code reader, a Quick Response (QR) code reader, an RFID reader, a short-range wireless receiver (e.g., a Bluetooth receiver), an audio capture device (which may include one or more microphones arranged in various configurations), an audio output device (e.g., one or more speakers or other audio transducers that may be, for example, mounted in one or more earphones or earbuds), printers, projectors, additional storage devices, or any other suitable I/O device.

The display 232 may include one or more heads-up displays (i.e., displays including a projector arranged in an optical collimator configuration and a combiner to provide data without requiring a user to look away from his or her typical viewpoint), computer monitors, projectors, touchscreen displays, liquid crystal displays (LCDs), light-emitting diode displays, or flat panel displays, for example.

The communication device 234 may include one or more devices that enable wireless and/or wired communication between various devices instantiating the content access regulation system 200 and with devices external to the content access regulation system 200. In particular, the communication device 234 may enable one or more of the communication pathways 108, 110, and 112 of FIG. 1, and may include suitable hardware for supporting the communication pathways 108, 110, and 112, such as network interface cards, modems, WiFi devices, Bluetooth devices, Near Field Communications (NFC) devices, and so forth.

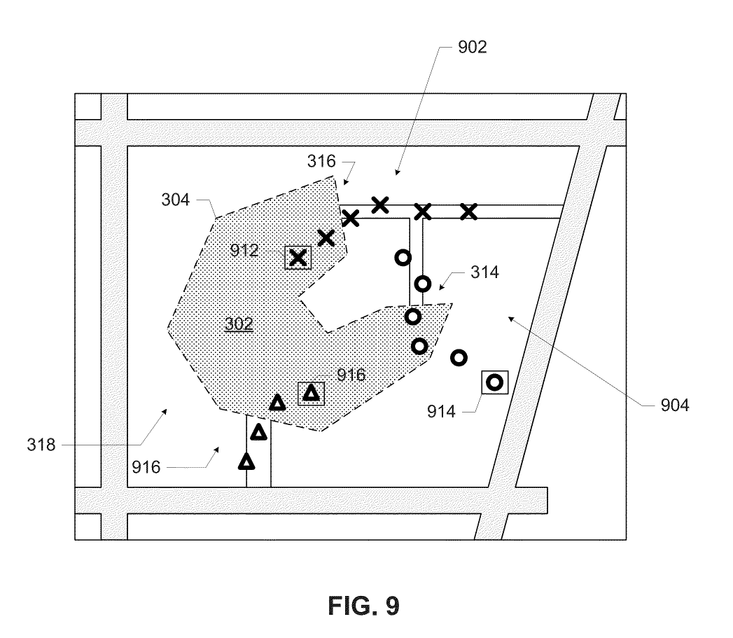

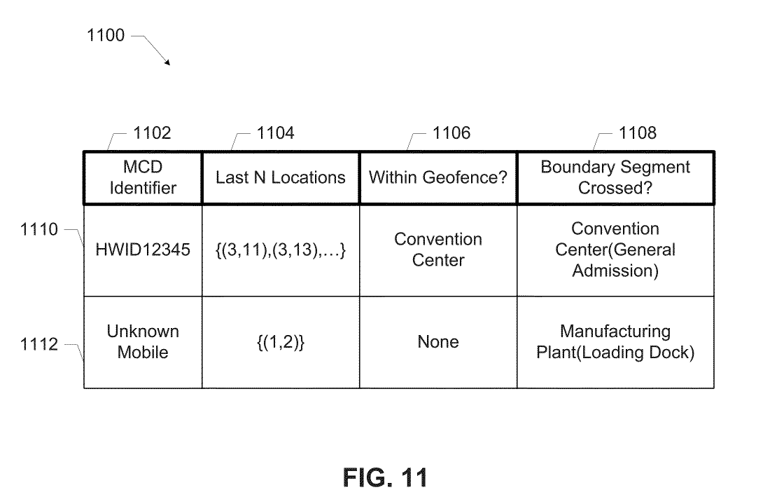

The content access regulation system 200 may include control operations logic 202. The control operations logic 202 may include an I/O device interface 238 configured to receive data from the I/O devices 230, and logic components configured to process information provided by the I/O devices 230 and output the results of the processing to the I/O devices 230. Although the components of the control operations logic 202 are illustrated separately, the components may be combined or divided as suitable, and each may use one or more of the results generated by others in performing its own processing, as discussed below. Data may be communicated between the components of the control operations logic 202 over a physical bus, a long-distance wired communication pathway, a short- or long-distance wireless communication pathway, or any combination of communication pathways. The content access regulation system 200 may include a storage device 236. In some embodiments, the storage device 236 may include one or more databases or other data storage structures, which may include memory structures for storing any of the data described herein used for geofence crossing control operations. Examples of data structures that may be included in the storage device 236 are discussed below (e.g., with reference to FIGS. 9 and 11). The storage device 236 may include any volatile or nonvolatile memory device, such as one or more hard drives, solid state logic, or portable storage media, for example.

The control operations logic 202 may include location logic 204, which may be configured to generate a location signal indicative of a location (which may be a range of locations) in which the mobile computing device 102 may be located and to provide the location of the mobile computing device 102 to the boundary segment crossing logic 208 (discussed below). The location signal may be an electronic signal that encodes information about the location.

The location may take any of a number of forms, and may be expressed in any desired coordinates or measurement units (e.g., latitude/longitude, English or metric units, etc.). For example, in some embodiments, the location of the mobile computing device 102 may be represented by a circular location boundary defined by a nominal location and an accuracy radius. In some such embodiments, a location signal indicative of this location may encode the nominal location and the accuracy radius. In some embodiments, the location of the mobile computing device 102 may be represented by an irregular location boundary. In some such embodiments, the location signal indicative of the location may encode a number of points along the location boundary, and may also include an interpolation rule for interpolating between the points. In some other such embodiments, the location logic 204 may be preprogrammed with an interpolation rule. In some embodiments, the location of the mobile computing device 102 may be represented by a polygon location range boundary defined by a number of location range boundary corners connected by location range boundary segments. In some such embodiments, a location signal indicative of the location may encode the location range boundary corners, and the location range boundary corners may be ordered or otherwise tagged to indicate which location range boundary corners are adjacent. In some embodiments of a polygon location range boundary, a location signal may also include the location range boundary segments, while in other embodiments, the location logic 204 may be preprogrammed to interpolate between the location range boundary corners to identify the location range boundary segments.

In some embodiments, the control operations logic 202 may not include the location logic 204. Instead, the location logic 204 may be included in an external device, and the location signal representative of the location of the computing device 102 may be communicated to the control operations logic 202 via the communication device 234 and the I/O device interface 238.

Any of the forms of the locations discussed above may be used to describe the geofence with respect to which the location/trajectory of the mobile computing device 102 will be evaluated (as discussed below). For example, a geofence may be described by a center point and a radius, by a number of points along a regular boundary, or by a number of corner points for a polygonal boundary. Any of these representations of the geofence boundary may be stored in the storage device 236, and may be accessed by the boundary segment crossing logic 208 when determining whether a trajectory of the mobile computing device 102 satisfies boundary segment crossing criteria, as discussed below. The storage device 236 may store data representative of the boundaries of a number of geofences. For example, the storage device 236 may store “Manufacturing Plant” and “Convention Center” geofences, as illustrated in FIG. 9 and discussed below.

Location data for the mobile computing device 102 may be associated with an estimated accuracy, which may be a function of the hardware used to generate the location data. The required accuracy of a location measurement in order to “trust” the location measurements enough to proceed with the content access regulation techniques disclosed herein may be predetermined, and may depend on the security level desired for regulating access to content. For example, when the content is highly sensitive military or industrial information, a very accurate location measurement may be required. When the content is less sensitive (e.g., in a performance venue or for other entertainment purposes), a less accurate location measurement may be tolerated.

The control operations logic 202 may include trajectory logic 206, which may be configured to generate a trajectory signal indicative of a trajectory traveled by the mobile computing device 102 and provide the trajectory signal to the boundary segment crossing logic 208. In some embodiments, the trajectory logic 206 may be configured to assemble multiple location signals, from the location logic 204, indicative of multiple previous locations of the mobile computing device 102 to generate the trajectory signal. In some embodiments, the trajectory logic 206 may extrapolate from these multiple previous locations to determine a likely speed at which the mobile computing device 102 is moving and a direction in which the mobile computing device 102 is moving in order to project a future trajectory. The trajectory signal may be an electronic signal that encodes information about the trajectory of the mobile computing device 102.

As noted above, in some embodiments, the trajectory logic 206 may generate the trajectory signal based on the location signals generated by the location logic 204. In particular, the trajectory logic 206 may receive location signals indicative of the location of the mobile computing device 102 at two different times, and may compare the two location signals to determine the trajectory. For example, in embodiments in which the location is a circular range defined by a nominal location and an accuracy radius, the trajectory logic 206 may compare the nominal location of the first location signal and the nominal location of the second location signal and determine the trajectory by interpolating between the two nominal locations. In other embodiments, the trajectory logic 206 may generate the trajectory signal based on signals in addition to the location signal. For example, when the I/O devices 230 include an accelerometer, the trajectory logic 206 may determine a speed by integrating the acceleration signal from the accelerometer over a predetermined window. When the I/O devices 230 include a compass, the trajectory logic 206 may determine a direction based on a direction signal from the compass. Any other technique for trajectory determination may be used.

As noted above with reference to the location logic 204, the trajectory logic 206 may determine trajectories in any suitable number of dimensions (e.g., two or three). In embodiments of the latter, for example, the trajectory logic 206 may distinguish whether the trajectory of the mobile computing device 104 entered an area using the stairs or using an elevator.

In some embodiments, the control operations logic 202 may not include the trajectory logic 206. Instead, the trajectory logic 206 may be included in an external device, and the trajectory signal may be communicated to the control operations logic 202 via the communication device 234 and the I/O device interface 238.

The control operations logic 202 may include boundary segment crossing logic 208, which may be coupled with the location logic 204 and the trajectory logic 206, and may be configured to determine whether the mobile computing device 102 satisfies boundary segment crossing criteria (stored, for example, in the storage device 236) based on the trajectory signal (generated by the trajectory logic 206). In particular, the boundary segment crossing criteria may include that the mobile computing device 102 crossed a predetermined segment of a geofence boundary (stored, for example, in the storage device 236) into an area defined by the geofence boundary. The predetermined segment of the geofence boundary may represent less than the entire geofence boundary.

As discussed above with reference to the location logic 204 and the trajectory logic 206, the predetermined segment of the geofence boundary may be defined in any suitable number of dimensions (e.g., two or three). al noticed that altitude was mentioned once and may not need to be highlighted, but trajectories could include traversals through 3-dimensional geo-boundary segments. For example, if a three-dimension geofence described the second floor of a building, the predetermined segment may be the bottom “panel” of that three-dimensional geofence (e.g., the portion of the geofence adjacent to both the first and second floors). This would distinguish between mobile computing devices that entered the three-dimensional geofenced area using an expected trajectory (e.g., the stairs or an elevator) or an unexpected trajectory (e.g., through the ceiling from the third floor).

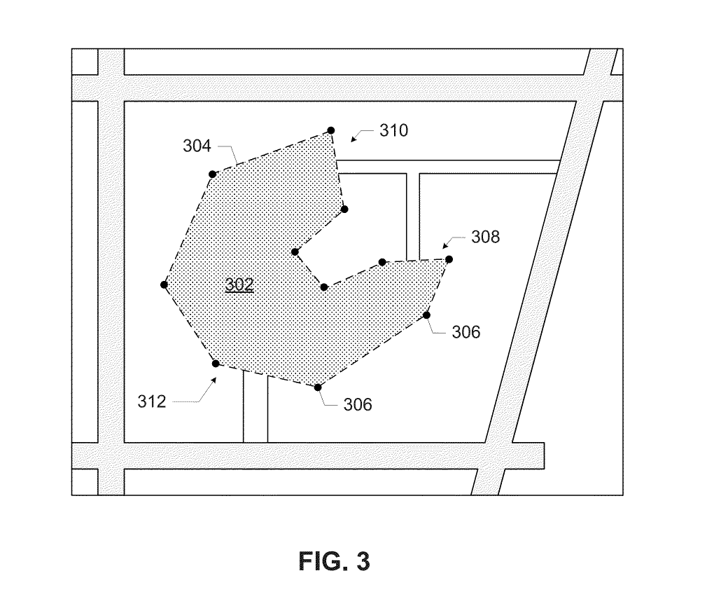

For example, FIG. 3 is a map view of an illustrative geofence boundary 304, in accordance with various embodiments. The geofence boundary 304 may correspond to the perimeter of a building, and may define a geofence area 302. The geofence boundary 304 illustrated in FIG. 3 may be a polygonal geofence defined by line segments between vertices 306. For ease of illustration, only a few of the vertices 306 are labeled in FIG. 3. The building to which the geofence boundary 304 corresponds may include three entrances: a first entrance 308, a second entrance 310, and a third entrance 312. Although buildings may be used as examples of geofenced areas herein, the embodiments of the present disclosure may be applied to any geofenced area, such as an outdoor park. Additionally, the direction of travel across a geofence boundary may be used to differentiate entrance to and exit from the geofenced area.

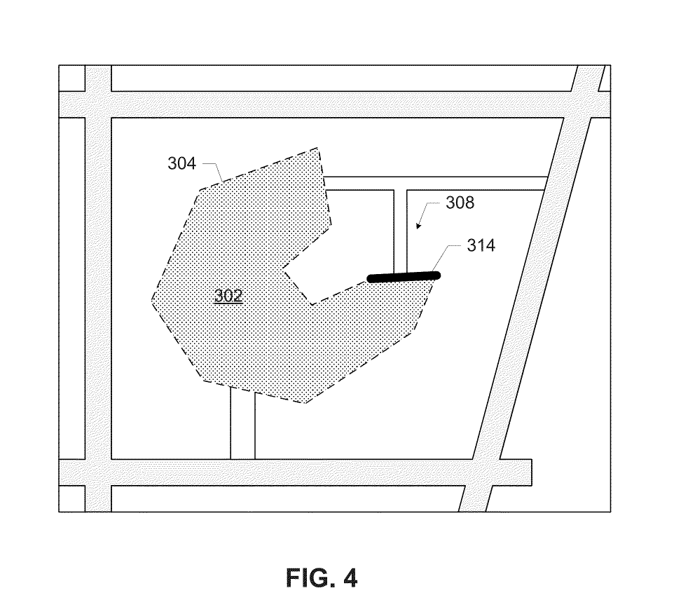

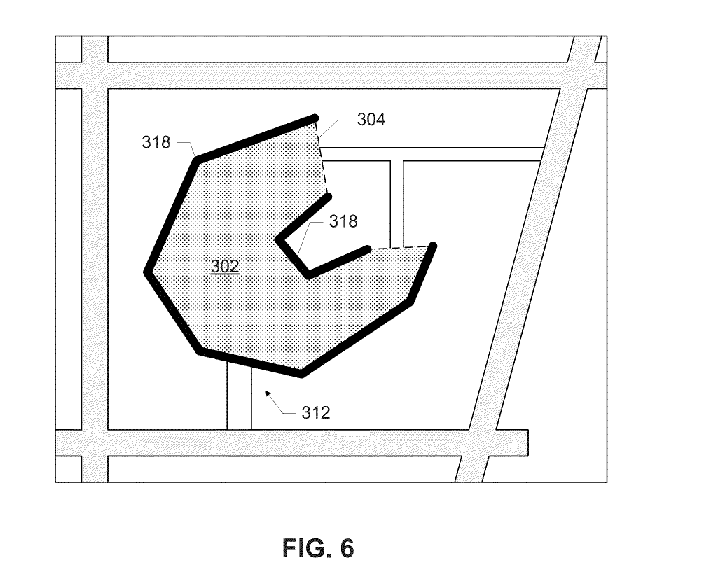

FIGS. 4-6 are map views of illustrative boundary segments of the geofence boundary 304 of FIG. 3, in accordance with various embodiments. In particular, FIG. 4 illustrates a first boundary segment 314. The first boundary segment 314 may represent a portion of the geofence boundary 304, and may correspond to the geographic location of the first entrance 308. Boundary segment crossing criteria associated with the first boundary segment 314 may include that the mobile computing device 102 crossed the first boundary segment 314. Although the first boundary segment 314 is coextensive with a line segment between two vertices defining the geofence boundary 304, this need not be the case, and a boundary segment of a polygonal geofence may include less than all of a line segment and/or portions of one or more line segments (e.g., as discussed below with reference to FIG. 6). A boundary segment may correspond to any predetermined portion or set of portions of the geofence boundary, such that the boundary segment is less than the entire geofence boundary.

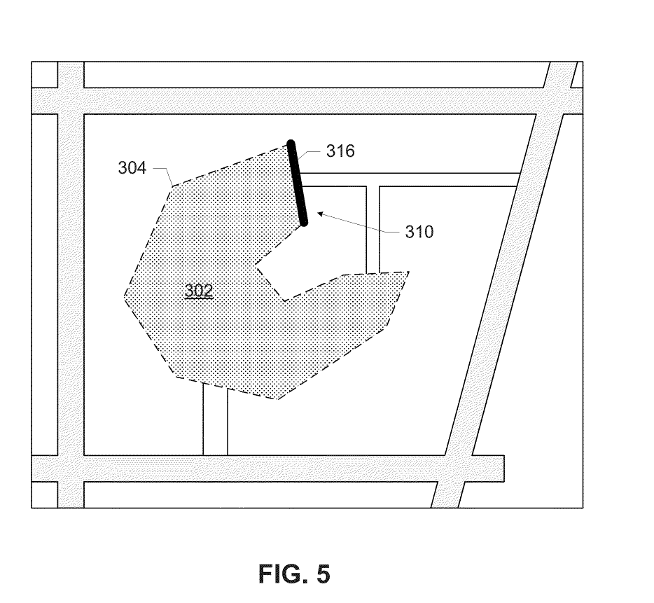

FIG. 5 illustrates a second boundary segment 316. The second boundary segment 316 may represent a portion of the geofence boundary 304, and may correspond to the geographic location of the second entrance 310. Boundary segment crossing criteria associated with the second boundary segment 316 may include that the mobile computing device 102 crossed the second boundary segment 316. As noted above with reference to the first boundary segment 314, although the entire second boundary segment 316 is coextensive with a line segment between two vertices defining the geofence boundary, this need not be the case.

FIG. 6 illustrates a third boundary segment 318. The third boundary segment 318 may represent multiple discontinuous portions of the geofence boundary, and may include the geographic location of the third entrance 312 (as well as many other portions of the geofence boundary 304). In some embodiments, the third boundary segment 318 may be defined as the remaining portions of the geofence boundary 304 after the first boundary segment 314 and the second boundary segment 316 are considered. In other words, the third boundary segment 318 may be defined as the portions of the geofence boundary 304 that are not included in the first boundary segment 314 or the second boundary segment 316. Boundary segment crossing criteria associated with the third boundary segment 318 may include that the mobile computing device 102 crossed the third boundary segment 318.

In some embodiments, the boundary segment crossing criteria associated with a particular segment of a geofence boundary may include a requirement that the mobile computing device 102 is currently located in the area defined by the geofence boundary. That is, the boundary segment crossing criteria may require both that the mobile computing device 102 cross a particular segment of the geofence boundary, and that the mobile computing device 102 be located within the geofence boundary (and has not yet traveled outside the geofence boundary). For example, the boundary segment crossing criteria associated with the first boundary segment 314 of the geofence boundary 304 (FIG. 4) may require both that the mobile computing device 102 cross the first boundary segment 314 and that the mobile computing device 102 be located in the area 302 defined by the geofence boundary 304. Any suitable techniques may be used to determine whether the mobile computing device 102 is within the area defined by a geofence boundary (e.g., a “point in polygon” technique for use with a polygonal geofence boundary). In other embodiments, the boundary segment crossing criteria may require that the mobile computing device 102 crossed a particular segment of the geofence boundary and was within the geofenced area at some previous point in time, but does not require that the mobile computing device 102 is currently within the geofence boundary.

In some embodiments, the boundary segment crossing criteria associated with a particular segment of a geofence boundary may include other requirements in addition to the crossing of the particular segment. For example, in an industrial facility, the boundary segment crossing criteria may include that the mobile computing device 102 has been previously registered (e.g., via hardware identifier) in a database of authorized devices (e.g., stored in the storage device 236), and was recognized by a security desk computer coupled to that database. In some embodiments, a hardware identifier of the mobile computing device 102 may be associated with an employee badge number, RFID tag, or bar code in a database (e.g., stored in the storage device 236), and the boundary segment crossing criteria may include that the employee badge was properly scanned by a security desk computer coupled to that database. Any other suitable criteria may be included in the boundary segment crossing criteria.

In some embodiments, when the storage device 236 stores data about multiple geofences, the boundary segment crossing logic 208 may determine whether the mobile computing device 102 satisfies boundary segment crossing criteria for each of the multiple geofences. In particular, the boundary segment crossing logic 208 may process the trajectory signal with respect to multiple geofence boundaries and/or multiple boundary segments (e.g., in parallel, in series, or in any combination) and may determine whether the mobile computing device 102 satisfies boundary segment crossing criteria for each of the multiple geofences. For example, the boundary segment crossing logic 208 may process a trajectory signal with respect to the first boundary segment 314, the second boundary segment 316, and the third boundary segment 318 of the geofence boundary 304. Moreover, as discussed below with reference to FIG. 9, the boundary segment crossing logic 208 may process a trajectory signal with respect to multiple geofences (e.g., the “Manufacturing Plan” and the “Convention Center”).

The control operations logic 202 may include content access logic 210, which may be coupled with the boundary segment crossing logic 208, and may be configured to, in response to a determination by the boundary segment crossing logic 208 that the mobile computing device 102 satisfies a set of boundary segment crossing criteria, provide a content identifier associated with the predetermined segment of the geofence boundary to the mobile computing device 102. For example, if the boundary segment crossing logic 208 determines that the mobile computing device 102 satisfies a set of boundary segment crossing criteria associated with a first geofence boundary segment, the content access logic 210 may provide a content identifier associated with the first geofence boundary segment to the mobile computing device 102.

The content identifier provided by the content access logic 210 may take any of a number of forms. For example, in some embodiments, the content identifier may be a website address or other resource locator (e.g., any other suitable uniform resource identifier). Upon receipt of the website address or other resource locator, the mobile computing device 102 may access the website address or other resource locator and provide the content located there to the user of the mobile computing device 102. In some embodiments, the content identifier may be a credential that the mobile computing device 102 may provide to a server for access to content. For example, the content identifier may be a certificate identifying the mobile computing device 102 as authorized to access certain content; upon receipt of the content identifier, the mobile computing device 102 may access a server (e.g., via a website), provide the certificate to the server, and thereby gain access to particular content not available without the certificate. At business locations, the content identifier may be a certificate that allows the mobile computing device 102 to access business-related servers and other computing resources (e.g., business intranets, scheduling systems, and other internal computing resources). In some embodiments, the content identifier may be content itself. For example, the content identifier may be an image that includes a coupon or ticket. The content identifier may be a media file (such as an image, video, or audio file). The content identifier may be a multimedia file.

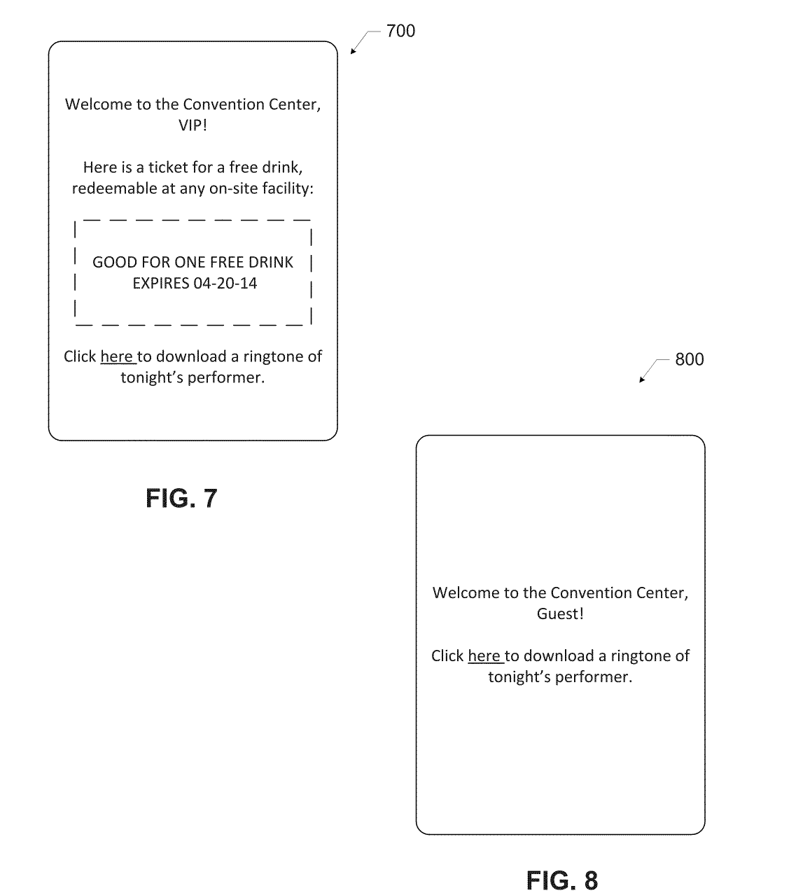

FIGS. 7 and 8 depict illustrative content displays 700 and 800, respectively, that may be provided to the mobile computing device 102 when different boundary segment crossing criteria are satisfied, in accordance with various embodiments. The content displays 700 and 800 may be rendered based on files included in content identifiers provided to the mobile computing device 102 or based on data accessed using the content identifiers provided to the mobile computing device 102 (e.g., at a website included in the content identifier or using a certificate included in the content identifier).

The content display 700 may represent content provided to the mobile computing device 102 when the mobile computing device 102 satisfies boundary segment crossing criteria associated with a VIP entrance to a venue for a concert. For example, if the building associated with the geofence boundary 304 (FIG. 3) is the venue, the VIP entrance may be the first entrance 308 and may correspond to the first boundary segment 314. When the mobile computing device 102 crosses the first boundary segment 314 (as part of admission to the venue with a VIP ticket or other credential), the boundary segment crossing logic 208 may determine that the mobile computing device 102 satisfies boundary segment crossing criteria associated with the first boundary segment 314 and the content access logic 210 may provide a content identifier to the mobile computing device 102 to enable the mobile computing device 102 to render the content display 700.

As shown in FIG. 7, the content display 700 may identify the venue associated with the geofence (“Convention Center”), and may identify the entrance through which the mobile computing device 102 entered the venue (“VIP”), as determined by association with the first boundary segment 314. The content display 700 may include an image or text that provides a ticket for a free drink to the user of the mobile computing device 102. The content display 700 may also include a link selectable by the user of the mobile computing device 102 to download a ring tone of the performer at the venue.

The content display 800 may represent content provided to the mobile computing device 102 when the mobile computing device 102 satisfies boundary segment crossing criteria associated with a General Admission entrance to a venue for a concert. For example, if the building associated with the geofence boundary 304 (FIG. 3) is the venue, the General Admission entrance may be the second entrance 310 and may correspond to the second boundary segment 316. When the mobile computing device 102 crosses the second boundary segment 316 (as part of admission to the venue with a General Admission ticket or other credential), the boundary segment crossing logic 208 may determine that the mobile computing device 102 satisfies boundary segment crossing criteria associated with the second boundary segment 316 and the content access logic 210 may provide a content identifier to the mobile computing device 102 to enable the mobile computing device 102 to render the content display 800.

As shown in FIG. 8, the content display 800 may identify the venue associated with the geofence (“Convention Center”), and may identify the entrance through which the mobile computing device 102 entered the venue (“Guest,” corresponding to General Admission), as determined by association with the second boundary segment 316. The content display 800 may also include a link selectable by the user of the mobile computing device 102 to download a ring tone of the performer at the venue. The content display 800 may not include the drink ticket of the content display 700. Thus, in this manner, different content may be provided to mobile computing devices that enter the venue through different entrances. In some embodiments, a user of a mobile computing device 102 that enters the venue through a VIP entrance may receive access to all of the content accessible to a user of a mobile computing device 102 that enters the venue through the General Admission entrance, plus additional content.

In some embodiments, the content identifier provided by the content access logic 210 may expire after a predetermined period of time, when the boundary segment crossing criteria are no longer satisfied, or when another set of content identifier revocation criteria are satisfied. For example, the content identifier provided by the content access logic 210 may be configured to expire after one hour of grant (e.g., by no longer being usable by the mobile computing device 102 or by no longer being recognized by a server to which the mobile computing device provides the content identifier). The mobile computing device 102 may be configured to seek renewal of a content identifier (or a new content identifier) prior to expiration. Content identifier revocation criteria may include that the mobile computing device 102 is no longer located in the area defined by the geofence boundary, that a user associated with the mobile computing device 102 is no longer authorized to access the content, that the mobile computing device 102 fails to meet a set of criteria for required security hardware, or any other suitable criteria. In some embodiments, the content identifier may not be set to expire at any predetermined time or under any predetermined set of conditions.

In some embodiments, the content access logic 210 may also be configured to transmit a signal representative of the satisfaction of the boundary segment crossing criteria by the mobile computing device 102 to another component of the computing system 100 for storage in order to “log” the fact that the mobile computing device 102 has satisfied the boundary segment crossing criteria. This logging may be part of a security protocol for monitoring which mobile computing devices have satisfied various boundary segment crossing criteria and have been provided various content identifiers.

FIG. 9 is a map view of various mobile computing device trajectories through and around the illustrative geofence boundary 304 of FIG. 3, in accordance with various embodiments. In particular, FIG. 9 depicts a trajectory 902 of a first mobile computing device 102 (with previous locations of the first mobile computing device 102 indicated by crosses (×)), a trajectory 904 of a second mobile computing device 102 (with previous locations of the second mobile computing device 102 indicated by circles (◯), and a trajectory 906 of a third mobile computing device 102 (with previous locations of the third mobile computing device 102 indicated by triangles).

The first mobile computing device 102 may have a trajectory 902 that crosses the second boundary segment 316 (FIG. 5) of the geofence boundary 304, and may have a latest location 912 within the area 302 defined by the geofence boundary 304. The boundary segment crossing logic 208 may determine that the trajectory 902 crosses the second boundary segment 316, and if the boundary segment crossing criteria associated with the second boundary segment 316 also requires that the first mobile computing device 102 be currently located in the area 302, the boundary segment crossing logic 208 may determine that the first mobile computing device 102 also satisfies that requirement. The content access logic 210 may provide a content identifier associated with the second boundary segment 316 to the first mobile computing device 102 if the first mobile computing device 102 satisfies the boundary segment crossing criteria associated with the second boundary segment 316.

The second mobile computing device 102 may have a trajectory 904 that crosses the first boundary segment 314 (FIG. 4) of the geofence boundary 304, and may have a latest location 914 outside the area 302 defined by the geofence boundary 304. The boundary segment crossing logic 208 may determine that the trajectory 904 crosses the first boundary segment 314. However, if the boundary segment crossing criteria associated with the first boundary segment 314 also requires that the second mobile computing device 102 be currently located in the area 302, the boundary segment crossing logic 208 may determine that the second mobile computing device 102 does not satisfy that requirement. The content access logic 210 may provide a content identifier associated with the first boundary segment 314 to the second mobile computing device 102 if the second mobile computing device 102 satisfies the boundary segment crossing criteria associated with the first boundary segment 314.

The third computing device 102 may have a trajectory 906 that crosses the third boundary segment 318 (FIG. 6) of the geofence boundary 304, and may have a latest location 916 within the area 302 defined by the geofence boundary 304. The boundary segment crossing logic 208 may determine such that the trajectory 906 crosses the third boundary segment 318, and if the boundary segment crossing criteria associated with the third boundary segment 318 also requires that the third mobile computing device 102 be currently located in the area 302, the boundary segment crossing logic 208 may determine that the third mobile computing device 102 also satisfies that requirement. However, if the third boundary segment 318 does not have any particular content identifier associated with it (e.g., the third boundary segment 318 is not considered an authorized entrance or no particular content is to be provided to mobile computing devices 102 that enter the area 302 via the third boundary segment 318, the content access logic 210 may provide no content identifier to the third mobile computing device 102 upon determination by the boundary segment crossing logic 208 that the third mobile computing device 102 does not satisfy the boundary segment crossing criteria associated with the “authorized” entrances corresponding to the first boundary segment 314 and the second boundary segment 316.

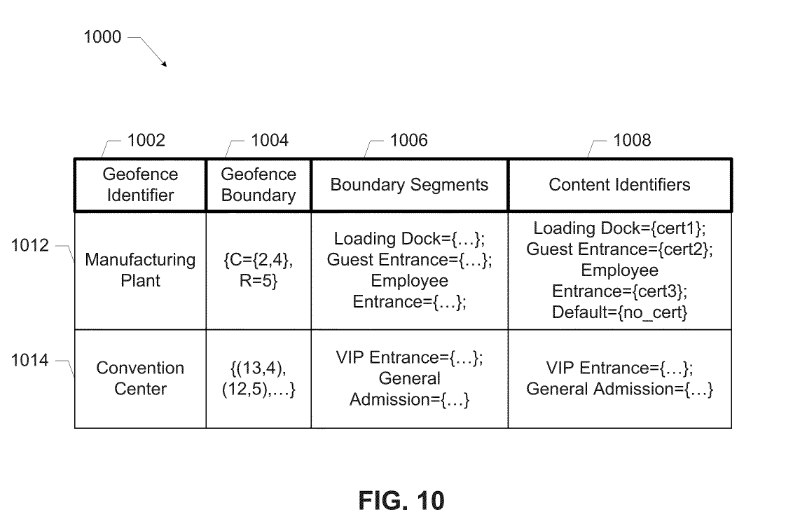

The storage device 236 may include any suitable data structures for storing data used or generated by any of the control operations logic 202 discussed herein to support any of the operations discussed herein. FIG. 10 illustrates an example data structure 1000 that may be used to store geofence, boundary segment, and content identifier data, in accordance with various embodiments. The data structure 1000 includes a geofence identifier field 1002, a geofence boundary field 1004, a boundary segments field 1006, and a content identifiers field 1008. The data structure 1000 also includes two illustrative entries 1012 and 1014.

The geofence identifier field 1002 may be configured to store an identifier (e.g., a textual description, address, or name) of a particular geofence. The entry 1012 includes the geofence identifier “Manufacturing Plant” and the entry 1014 includes the geofence identifier “Convention Center.”

The geofence boundary field 1004 may be configured to store a definition of the boundary of the geofence associated with the geofence identifier in the geofence identifier field 1002. As noted above, a geofence boundary may be defined in any of a number of ways, such as with a nominal center point and an accuracy radius or with an ordered set of vertices connected by line segments to form a polygonal geofence. The entry 1012 includes a geofence boundary definition specified by a nominal center point and an accuracy radius, and the entry 1014 includes a geofence boundary definition specified by an ordered set of vertices.

The boundary segments field 1006 may be configured to store definitions of one or more segments of the geofence boundary defined in the geofence boundary field 1004. As noted above, each individual ones of the segments may represent less than the entire geofence boundary. In some embodiments, the boundary segments may be identified by textual descriptors. The boundary segments included in the boundary segments field 1006 need not cover the entire geofence boundary. The boundary segments may be defined in any suitable manner, such as in accordance with any of the techniques described above for defining a geofence boundary. The entry 1012 includes three boundary segment definitions corresponding to “Loading Dock,” “Guest Entrance,” and “Employee Entrance,” respectively. The entry 1014 includes two boundary segment definitions corresponding to “VIP Entrance” and “General Admission,” respectively. Note that, in some embodiments, a boundary segment may be defined implicitly as being the remainder of the geofence boundary “left over” after the boundary segments enumerated in the boundary segments field 1006 are considered. For example, the boundary segment 318 (FIG. 6) of the geofence boundary 304 may be defined implicitly as the remainder of the boundary 304 once the boundary segments 314 and 316 (FIGS. 4 and 5) have been “subtracted.”

The content identifiers field 1008 may be configured to store content identifiers or pointers to content identifiers associated with the boundary segments defined in the boundary segments field 1006. Additionally, the content identifiers field 1008 may include a “default” content identifier to be provided to a mobile computing device under a default set of conditions stored in the storage device 236 (e.g., crossing into a geofence area without passing through one of the predetermined boundary segments). In some embodiments, the default content identifier may be empty, signifying that no content identifier is to be provided unless the mobile computing device 102 satisfies a set of boundary segment crossing criteria. In some embodiments, no default content identifier may be stored in the data structure 1000. The entry 1012 refers to four content identifiers corresponding to the three boundary segment definitions in the boundary segments field 1006 and a “default” content identifier. The entry 1014 refers to two content identifiers corresponding to the two boundary segment definitions in the boundary segments field 1006, and no “default” content identifier.

In embodiments in which the boundary segment crossing criteria include additional criteria (e.g., related to the time of crossing or other required conditions), additional fields may be included in the data structure 1000 to describe these additional criteria.

FIG. 11 illustrates an example data structure 1100 that may be used to store mobile computing device data for regulating access to content via boundary segment crossings, in accordance with various embodiments. The data structure 1000 includes a mobile computing device (MCD) identifier field 1102, a last N locations field 1104, a within geofence field 1106, and a boundary segment crossed field 1108. The data structure 1100 also includes two illustrative entries 1110 and 1112. As discussed below, in some embodiments, the data structure 1100 may be linked to the data structure 1000 so that geofence and boundary segment definitions stored in the data structure 1000 may be referred to in the data structure 1100 (and vice versa).

The mobile computing device identifier field 1102 may be configured to store an identifier of a particular mobile computing device (e.g., a mobile computing device configured in accordance with the embodiments disclosed herein for the mobile computing device 102). In some embodiments, a mobile computing device identifier may be a hardware identifier, identifying a processing device, a network communication device, or any other hardware device substantially unique to a mobile computing device. In some embodiments, a mobile computing device identifier may be a user generated name for the mobile computing device (e.g., “Jeffs phone”). The entry 1110 includes a hardware identifier in the mobile computing device identifier field 1102. The entry 1112 indicates that no mobile computing device identifier is available for the corresponding mobile computing device, and a placeholder mobile computing device identifier has been included in the mobile computing device identifier field 1102.

The last N locations field 1104 may be configured to store the most recent N location samples or measurements of the mobile computing device identified in the mobile computing device identifier field 1102. The number N may be any desired integer. The field 1104 may be populated by the location logic 204 and may be utilized by the trajectory logic 206 to determine a trajectory of the mobile computing device identified in the mobile computing device identifier field 1102. In some embodiments, the field 1104 may not be configured to include a fixed number of location samples, and may instead include as many location samples as are available within a predetermined time window (e.g., in the last thirty seconds, or five minutes), for example, or any other suitable amount of location data. The entry 1110 includes multiple sets of coordinates representative of the last N locations of the mobile computing device identified by the mobile computing device identifier field 1102. The entry 1112 includes one set of coordinates representative of the last location of the mobile computing device identified by the mobile computing device identifier field 1102 (e.g., because only one location measurement may be available).

The within geofence field 1106 may be configured to store a determination by the boundary segment crossing logic 208 that the mobile computing device identified by the mobile computing device identifier field 1102 is currently within zero, one, or more geofences (e.g., based on the latest location of the mobile computing device as stored in the last N locations field 1104 and processed by the location logic 204). In particular, the within geofence field 1106 may list all geofences in which the mobile computing device identified by the mobile computing device identifier field 1102 is located. Since geofences may overlap, it is possible for a single mobile computing device to be within two or more geofences. The entry 1110 includes an indicator that the mobile computing device identified by the mobile computing device identifier field 1102 is within the “Convention Center” geofence (as discussed above with reference to the data structure 1000). The entry 1112 includes an indicator that the mobile computing device identified by the mobile computing device identifier field 1102 is not within any predetermined geofence. In embodiments in which none of the boundary segment crossing criteria for segments of a particular geofence include the criteria that the mobile computing device is located within the geofence, the within geofence field 1106 may not be included in the data structure 1100.

The boundary segment crossed field 1108 may be configured to store a determination by the boundary segment crossing logic 208 that the mobile computing device identified by the mobile computing device identifier field 1102 has crossed zero, one, or more boundary segments (e.g., based on the set of locations of the mobile computing device stored in the last N locations field 1104 and processed by the trajectory logic 206). Again, since geofences may overlap, it is possible for a single mobile computing device to have crossed two or more boundary segments. The entry 1110 includes an indicator that the mobile computing device identified by the mobile computing device identifier field 1102 has crossed the “General Admission” boundary segment of the “Convention Center” geofence (as discussed above with reference to the data structure 1000). The entry 1112 includes an indicator that the mobile computing device identified by the mobile computing device identifier field 1102 has crossed the “Loading Dock” boundary segment of the “Manufacturing Plant” geofence (as discussed above with reference to the data structure 1000).

In embodiments in which the boundary segment crossing criteria include additional criteria (e.g., related to the time of crossing or other required conditions), additional fields may be included in the data structure 1100 to store mobile computing device data related to these additional criteria and whether the mobile computing device identified by the mobile computing device identifier field 1102 satisfies these additional criteria.

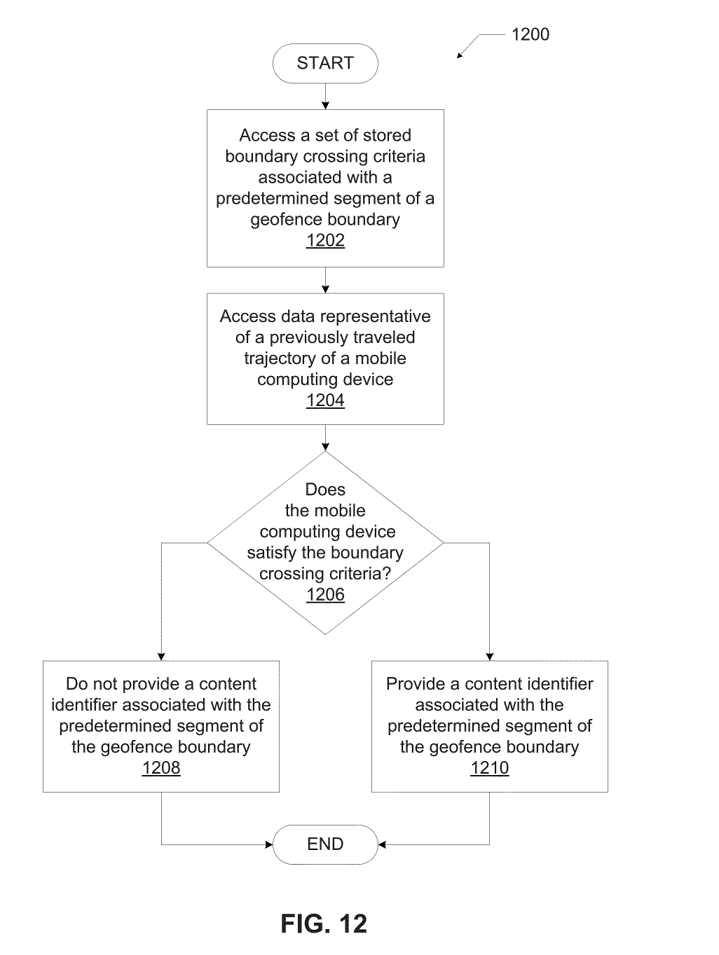

FIG. 12 is a flow diagram of a method 1200 for regulating access to content via boundary segment crossings, in accordance with various embodiments. The operations of the method 1200 (and the other methods described herein), although illustrated as performed in a particular sequence for the sake of illustration, may be performed in parallel as suitable or in any other order. For example, operations related to accessing a set of stored boundary segment crossing criteria and accessing data representative of a trajectory of a mobile computing device may be performed in parallel, partially in parallel, or in any suitable order, relative to each other.

Operations of the method 1200 (and the other methods described herein) may be described as performed by components of the system 200, as embodied in the computing system 100, for illustrative purposes, but the operations of the method 1200 (and the other methods described herein) may be performed by any suitably configured computing device or collection of computing devices. Any of the operations of the method 1200 (and the other methods described herein) may be performed in accordance with any of the embodiments of the systems 100 and 200 described herein. In particular, the operations of the method 1200 may be performed with reference to each predetermined segment of a geofence boundary with which a content identifier is associated, and for each predetermined geofence.

The method 1200 may begin at 1202, at which the content access regulation system 200 (e.g., the boundary segment crossing logic 208) may access a set of stored boundary segment crossing criteria indicative of a predetermined segment of a geofence boundary. The stored boundary segment crossing criteria may be stored in the storage device 236 in any suitable data structure (e.g., the data structure 1000 of

FIG. 10). The boundary segment crossing criteria may include that a mobile computing device (e.g., the mobile computing device 102) crossed a predetermined segment of a geofence boundary into an area defined by the geofence boundary. The predetermined segment of the geofence boundary may represent less than the entire geofence boundary. In some embodiments, the predetermined segment of the geofence boundary may correspond to a geographic location of a door or other entryway to a facility or location inside a facility (e.g., an airport or government building security area). In some embodiments, the boundary segment crossing criteria may include that the mobile computing device is currently located in the area defined by the geofence boundary.

At 1204, the content access regulation system 200 (e.g., the location logic 204 and/or the trajectory logic 206) may access data representative of a trajectory of a mobile computing device (e.g., the mobile computing device 102). The data representative of the trajectory may be stored in the storage device 236 in any suitable data structure (e.g., the data structure 1100 of FIG. 11). The data accessed at 1204 may be sufficient for evaluating the boundary segment crossing criteria accessed at 1202.

At 1206, the content access regulation system 200 (e.g., the boundary segment crossing logic 208) may determine whether the mobile computing device satisfies the boundary segment crossing criteria (accessed at 1202) based on the data representative of the trajectory of the mobile computing device (accessed at 1204). In some embodiments, the data representative of the trajectory of the mobile computing device may be provided to the boundary segment crossing logic 208 at 1206 by the location logic 204 and/or the trajectory logic 206.

If the content access regulation system 200 determines at 1206 that the mobile computing device does not satisfy the boundary segment crossing criteria associated with a particular segment of a geofence boundary, the content access regulation system 200 (e.g., the content access logic 210) may proceed to 1208 and may not provide a content identifier associated with the segment of the geofence boundary to the mobile computing device. The method 1200 may then end.

If the content access regulation system 200 determines at 1206 that the mobile computing device satisfies the boundary segment crossing criteria associated with a particular segment of a geofence boundary, the content access regulation system 200 (e.g., the content access logic 210) may proceed to 1210 and may provide a content identifier associated with the segment of the geofence boundary to the mobile computing device. In some embodiments, the content identifier may include a website address. In some embodiments, the content identifier may include a credential that the mobile computing device may provide to a server for access to content. In some embodiments, the content identifier may include an image. The content identifier may include content cells, or may enable the mobile computing device to access content. The process may then end.

In some embodiments, a system administrator or other user may define geofence boundaries and particular segments of those geofence boundaries for use with the systems and techniques disclosed herein through a graphical user interface (e.g., a web-based interface). This interface may include an Application Programming Interface (API) with existing mapping tools, and may allow the system administrator to draw geofence boundaries on a map, select segments of those geofence boundaries, and associate various boundary segment crossing criteria and content identifiers with those segments (e.g., by populating data structures like the data structure 1000). Any suitable interface and back-end hardware, as known in the art, may be used to support the creation and organization of geofence boundary, boundary segment, crossing criteria, and content identifier data.

As noted above, any of the embodiments disclosed herein may be used to grant access to content to other computing devices associated with a mobile device that satisfies geofence boundary crossing criteria. Thus, in some embodiments, the mobile device may serve as the “triggering” device that allows some or all additional devices associated with a common user to access content (e.g., by giving the user access to the content). For example, if a user's smartphone crosses a geofence boundary in a manner that satisfies boundary crossing criteria for access to a website, the user herself may be given access to the website so that the user may access the website from her laptop instead of or in addition to her smartphone.

The following paragraphs provide illustrative examples of some of the embodiments disclosed herein.

Example 1 is one or more computer readable media having instructions thereon that, in response to execution by one or more processing devices of a computing system, cause the computing system to: determine whether a mobile computing device satisfies boundary segment crossing criteria, wherein the boundary segment crossing criteria includes that the mobile computing device crossed a predetermined segment of a geofence boundary into an area defined by the geofence boundary, wherein the predetermined segment of the geofence boundary represents less than an entirety of the geofence boundary; and in response to a determination that the mobile computing device satisfied the boundary segment crossing criteria, provide a content identifier, associated with the predetermined segment of the geofence boundary, to the mobile computing device.

Example 2 may include the subject matter of Example 1, and may further specify that the boundary segment crossing criteria further includes that the mobile computing device is currently located in the area defined by the geofence boundary.

Example 3 may include the subject matter of any of Examples 1, and may further specify that the predetermined segment of the geofence boundary corresponds to a geographic location of an entryway.

Example 4 may include the subject matter of any of Examples 1, and may further specify that the content identifier includes a website address.

Example 5 may include the subject matter of any of Examples 1, and may further specify that the content identifier includes a credential for provision, by the mobile computing device, to a server for access to content.

Example 6 may include the subject matter of any of Examples 1, and may further specify that the content identifier includes an image.

Example 7 may include the subject matter of any of Examples 1-6, and may further have instructions thereon that, in response to execution by the one or more processing devices of the computing system, cause the computing system to: determine whether the mobile computing device satisfies second boundary segment crossing criteria, wherein the second boundary segment crossing criteria includes that the mobile computing device crossed a second predetermined segment of the geofence boundary into the area defined by the geofence boundary, and wherein the second predetermined segment of the geofence boundary is different from and non-overlapping with the predetermined segment of the geofence boundary; and in response to a determination that the mobile computing device satisfied the second boundary segment crossing criteria, provide a second content identifier associated with the second predetermined segment of the geofence boundary to the mobile computing device, wherein the second content identifier is different from the content identifier.

Example 8 may include the subject matter of any of Examples 1-6, and may further have instructions thereon that, in response to execution by the one or more processing devices of the computing system, cause the computing system to access a location of the mobile computing device.

Example 9 is a computing system for regulating access to content, including: a storage device; and boundary segment crossing logic, coupled to the storage device, to determine whether a mobile computing device satisfies boundary segment crossing criteria, store a result of the determination in the storage device, and notify a content access logic of the result of the determination. The boundary segment crossing criteria includes that the mobile computing device crossed a predetermined segment of a geofence boundary into an area defined by the geofence boundary; the predetermined segment of the geofence boundary represents less than an entirety of the geofence boundary; and the content access logic is to, in response to a determination by the boundary segment crossing logic that the mobile computing device satisfied the boundary segment crossing criteria, provide a content identifier, associated with the predetermined segment of the geofence boundary, to the mobile computing device.

Example 10 may include the subject matter of Example 9, and may further specify that the boundary segment crossing criteria further includes that the mobile computing device is currently located in the area defined by the geofence boundary.

Example 11 may include the subject matter of any of Examples 9-10, and may further specify that the predetermined segment of the geofence boundary corresponds to a geographic location of an entryway.

Example 12 may include the subject matter of any of Examples 9-10, and may further specify that the content identifier includes a website address.

Example 13 may include the subject matter of any of Examples 9-10, and may further specify that the storage device has one or more memory structures to store the geofence boundary and to store the predetermined segment of the geofence boundary in association with the content identifier.

Example 14 may include the subject matter of any of Examples 9-10, and may further specify that: the boundary segment crossing logic is to further determine whether the mobile computing device satisfies second boundary segment crossing criteria, store a result of the further determination in the storage device, and notify the content access logic of the result of the further determination; the second boundary segment crossing criteria includes that the mobile computing device crossed a second predetermined segment of the geofence boundary into the area defined by the geofence boundary; the second predetermined segment of the geofence boundary is different from and non-overlapping with the predetermined segment of the geofence boundary, and the content access logic is to, in response to a determination that the mobile computing device satisfied the second boundary segment crossing criteria, provide a second content identifier associated with the second predetermined segment of the geofence boundary to the mobile computing device, wherein the second content identifier is different from the content identifier.

Example 15 may include the subject matter of any of Examples 9-10, and may further include location logic, coupled to the boundary segment crossing logic, to provide a location of the mobile computing device to the boundary segment crossing logic.

Example 16 may include the subject matter of any of Examples 9-10, and may further include trajectory logic, coupled to the boundary segment crossing logic, to provide a trajectory traveled by the mobile computing device to the boundary segment crossing logic.

Example 17 may include the subject matter of any of Examples 9-10, and may further specify that the computing system is a same computing device as the mobile computing device.

Example 18 may include the subject matter of any of Examples 9-10, and may further include the content access logic.

Example 19 is a computing system for regulating access to content, including: a storage device; and content access logic, coupled to the storage device, to receive a result of a determination of whether a mobile computing device satisfies boundary segment crossing criteria, and in response to receiving a result that the mobile computing device satisfies the boundary segment crossing criteria, provide a content identifier, stored in the storage device and associated with the predetermined segment of the geofence boundary, to the mobile computing device. The boundary segment crossing criteria includes that the mobile computing device crossed a predetermined segment of a geofence boundary into an area defined by the geofence boundary, and the predetermined segment of the geofence boundary represents less than an entirety of the geofence boundary.

Example 20 may include the subject matter of Example 19, and may further specify that the content identifier includes a credential for provision, by the mobile computing device, to a server for access to content.

Example 21 may include the subject matter of any of Examples 19-20, and may further specify that the content identifier includes an image.

Example 22 is a method for regulating access to content, including: determining, by a computing system, whether a mobile computing device satisfies boundary segment crossing criteria, wherein the boundary segment crossing criteria includes that the mobile computing device crossed a predetermined segment of a geofence boundary into an area defined by the geofence boundary, wherein the predetermined segment of the geofence boundary represents less than an entirety of the geofence boundary; and in response to determining that the mobile computing device satisfies the boundary segment crossing criteria, providing, by the computing system, a content identifier, associated with the predetermined segment of the geofence boundary, to the mobile computing device.

Example 23 may include the subject matter of Example 22, and may further specify that the boundary segment crossing criteria further includes that the mobile computing device is currently located in the area defined by the geofence boundary.

Example 24 may include the subject matter of any of Examples 22, and may further specify that the content identifier includes a credential for provision, by the mobile computing device, to a server for access to content.

Example 25 may include the subject matter of any of Examples 22, and may further specify that the content identifier enables access to multimedia content.

Example 26 may include the subject matter of any of Examples 22, and may further specify that the predetermined segment of the geofence boundary corresponds to a geographic location of an entryway.

Example 27 may include the subject matter of any of Examples 22, and may further specify that the content identifier includes a website address.

Example 28 may include the subject matter of any of Examples 22, and may further specify that the content identifier includes an image.

Example 29 may include the subject matter of any of Examples 22, and may further include: determining, by the computing system, whether the mobile computing device satisfies second boundary segment crossing criteria, wherein the second boundary segment crossing criteria includes that the mobile computing device crossed a second predetermined segment of the geofence boundary into the area defined by the geofence boundary, and wherein the second predetermined segment of the geofence boundary is different from and non-overlapping with the predetermined segment of the geofence boundary; and in response to a determination that the mobile computing device satisfied the second boundary segment crossing criteria, providing, by the computing system, a second content identifier associated with the second predetermined segment of the geofence boundary to the mobile computing device, wherein the second content identifier is different from the content identifier.

Example 30 may include the subject matter of any of Examples 22-29, and may further include accessing, by the computing system, a location of the mobile computing device.

Example 31 may include the subject matter of any of Examples 22-29, and may further include accessing, by the computing system, a trajectory traveled by the mobile computing device.

Example 32 may include the subject matter of any of Examples 22-29, and may further specify that the computing system is a same computing device as the mobile computing device.

Example 33 is an apparatus for regulating access to content, including: means for determining whether a mobile computing device satisfies boundary segment crossing criteria, wherein the boundary segment crossing criteria includes that the mobile computing device crossed a predetermined segment of a geofence boundary into an area defined by the geofence boundary, wherein the predetermined segment of the geofence boundary represents less than an entirety of the geofence boundary; and means for providing, in response to determining that the mobile computing device satisfies the boundary segment crossing criteria, a content identifier, associated with the predetermined segment of the geofence boundary, to the mobile computing device.

Example 34 may include the subject matter of Example 33, and may further specify that the boundary segment crossing criteria further includes that the mobile computing device is currently located in the area defined by the geofence boundary.

Example 35 may include the subject matter of any of Examples 33, and may further specify that the content identifier includes a credential for provision, by the mobile computing device, to a server for access to content.

Example 36 may include the subject matter of any of Examples 33, and may further specify that the content identifier enables access to multimedia content.

Example 37 may include the subject matter of any of Examples 33-36, and may further specify that the predetermined segment of the geofence boundary corresponds to a geographic location of an entryway.

Example 38 may include the subject matter of any of Examples 33-36, and may further specify that the content identifier includes a website address.

Example 39 may include the subject matter of any of Examples 33-36, and may further specify that the content identifier includes an image.

Example 40 may include the subject matter of any of Examples 33-36, and may further include: means for determining whether the mobile computing device satisfies second boundary segment crossing criteria, wherein the second boundary segment crossing criteria includes that the mobile computing device crossed a second predetermined segment of the geofence boundary into the area defined by the geofence boundary, and wherein the second predetermined segment of the geofence boundary is different from and non-overlapping with the predetermined segment of the geofence boundary; and means for providing, in response to a determination that the mobile computing device satisfied the second boundary segment crossing criteria, a second content identifier associated with the second predetermined segment of the geofence boundary to the mobile computing device, wherein the second content identifier is different from the content identifier.

Example 41 may include the subject matter of any of Examples 33-36, and may further include means for accessing a location of the mobile computing device.

Example 42 may include the subject matter of any of Examples 33-36, and may further include means for accessing a trajectory traveled by the mobile computing device.

Example 43 may include the subject matter of any of Examples 33-36, and may further specify that the apparatus is a same computing device as the mobile computing device.

Example 44 is one or more computer readable media having instructions thereon that, in response to execution by one or more processing devices of a computing system, cause the computing system to: determine whether a mobile computing device satisfies boundary segment crossing criteria; store a result of the determination in a storage device; and notify a content access logic of the result of the determination; wherein the boundary segment crossing criteria includes that the mobile computing device crossed a predetermined segment of a geofence boundary into an area defined by the geofence boundary; wherein the predetermined segment of the geofence boundary represents less than an entirety of the geofence boundary; and wherein the content access logic is to, in response to a determination by the boundary segment crossing logic that the mobile computing device satisfied the boundary segment crossing criteria, provide a content identifier, associated with the predetermined segment of the geofence boundary, to the mobile computing device.

Example 45 may include the subject matter of Example 44, and may further specify that the boundary segment crossing criteria further includes that the mobile computing device is currently located in the area defined by the geofence boundary.

Example 46 may include the subject matter of any of Examples 44, and may further specify that the predetermined segment of the geofence boundary corresponds to a geographic location of an entryway.

Example 47 may include the subject matter of any of Examples 44, and may further specify that the content identifier includes a website address.

Example 48 may include the subject matter of any of Examples 44-47, and may further specify that the storage device has one or more memory structures to store the geofence boundary and to store the predetermined segment of the geofence boundary in association with the content identifier.

Example 49 may include the subject matter of any of Examples 44-47, further having instructions thereon that, in response to execution by the one or more processing devices of the computing system, cause the computing system to: determine whether the mobile computing device satisfies second boundary segment crossing criteria; store a result of the further determination in the storage device; and notify the content access logic of the result of the further determination. The second boundary segment crossing criteria includes that the mobile computing device crossed a second predetermined segment of the geofence boundary into the area defined by the geofence boundary, the second predetermined segment of the geofence boundary is different from and non-overlapping with the predetermined segment of the geofence boundary, and the content access logic is to, in response to a determination that the mobile computing device satisfied the second boundary segment crossing criteria, provide a second content identifier associated with the second predetermined segment of the geofence boundary to the mobile computing device, wherein the second content identifier is different from the content identifier.

Example 50 may include the subject matter of any of Examples 44-47, further having instructions thereon that, in response to execution by the one or more processing devices of the computing system, cause the computing system to access a location of the mobile computing device.

Example 51 may include the subject matter of any of Examples 44-47, further having instructions thereon that, in response to execution by the one or more processing devices of the computing system, cause the computing system to access a trajectory traveled by the mobile computing device.

Example 52 may include the subject matter of any of Examples 44-47, and may further specify that the computing system is a same computing device as the mobile computing device.

Example 53 is one or more computer readable media having instructions thereon that, in response to execution by one or more processing devices of a computing system, cause the computing system to: receive a result of a determination of whether a mobile computing device satisfies boundary segment crossing criteria; and in response to receiving a result that the mobile computing device satisfies the boundary segment crossing criteria, provide a content identifier, stored in a storage device and associated with the predetermined segment of the geofence boundary, to the mobile computing device. The boundary segment crossing criteria includes that the mobile computing device crossed a predetermined segment of a geofence boundary into an area defined by the geofence boundary and the predetermined segment of the geofence boundary represents less than an entirety of the geofence boundary.

Example 54 may include the subject matter of Example 53, and may further specify that the content identifier includes a credential for provision, by the mobile computing device, to a server for access to content.

Example 55 may include the subject matter of any of Examples 53-54, and may further specify that the content identifier includes an image.

Example 56 is a method for regulating access to content, including: determining whether a mobile computing device satisfies boundary segment crossing criteria; storing a result of the determination in a storage device; and notifying a content access logic of the result of the determination. The boundary segment crossing criteria includes that the mobile computing device crossed a predetermined segment of a geofence boundary into an area defined by the geofence boundary; wherein the predetermined segment of the geofence boundary represents less than an entirety of the geofence boundary, and the content access logic is to, in response to a determination by the boundary segment crossing logic that the mobile computing device satisfied the boundary segment crossing criteria, provide a content identifier, associated with the predetermined segment of the geofence boundary, to the mobile computing device.

Example 57 may include the subject matter of Example 56, and may further specify that the boundary segment crossing criteria further includes that the mobile computing device is currently located in the area defined by the geofence boundary.

Example 58 may include the subject matter of any of Examples 56, and may further specify that the predetermined segment of the geofence boundary corresponds to a geographic location of an entryway.

Example 59 may include the subject matter of any of Examples 56-58, and may further specify that the content identifier includes a website address.

Example 60 may include the subject matter of any of Examples 56-58, and may further specify that the storage device has one or more memory structures to store the geofence boundary and to store the predetermined segment of the geofence boundary in association with the content identifier.

Example 61 may include the subject matter of any of Examples 56-58, further including: determining whether the mobile computing device satisfies second boundary segment crossing criteria; storing a result of the further determination in the storage device; and notifying the content access logic of the result of the further determination. The second boundary segment crossing criteria includes that the mobile computing device crossed a second predetermined segment of the geofence boundary into the area defined by the geofence boundary, the second predetermined segment of the geofence boundary is different from and non-overlapping with the predetermined segment of the geofence boundary, and the content access logic is to, in response to a determination that the mobile computing device satisfied the second boundary segment crossing criteria, provide a second content identifier associated with the second predetermined segment of the geofence boundary to the mobile computing device, wherein the second content identifier is different from the content identifier.

Example 62 may include the subject matter of any of Examples 56-58, further including accessing a location of the mobile computing device.

Example may include the subject matter of any of Examples 56-58, further including accessing a trajectory traveled by the mobile computing device.

Example 64 may include the subject matter of any of Examples 56-58, and may further specify that the computing system is a same computing device as the mobile computing device.

Example 65 is a method for regulating access to content, including: receiving a result of a determination of whether a mobile computing device satisfies boundary segment crossing criteria; and in response to receiving a result that the mobile computing device satisfies the boundary segment crossing criteria, providing a content identifier, stored in a storage device and associated with the predetermined segment of the geofence boundary, to the mobile computing device. The boundary segment crossing criteria includes that the mobile computing device crossed a predetermined segment of a geofence boundary into an area defined by the geofence boundary, and the predetermined segment of the geofence boundary represents less than an entirety of the geofence boundary.

Example 66 may include the subject matter of Example 65, and may further specify that the content identifier includes a credential for provision, by the mobile computing device, to a server for access to content.

Example 67 may include the subject matter of any of Examples 65-66, and may further specify that the content identifier includes an image.

Example 68 is an apparatus for regulating access to content, including: means for determining whether a mobile computing device satisfies boundary segment crossing criteria; means for storing a result of the determination in a storage device; and means for notifying a content access logic of the result of the determination. The boundary segment crossing criteria includes that the mobile computing device crossed a predetermined segment of a geofence boundary into an area defined by the geofence boundary; wherein the predetermined segment of the geofence boundary represents less than an entirety of the geofence boundary, and the content access logic is to, in response to a determination by the boundary segment crossing logic that the mobile computing device satisfied the boundary segment crossing criteria, provide a content identifier, associated with the predetermined segment of the geofence boundary, to the mobile computing device.

Example 69 may include the subject matter of Example 68, and may further specify that the boundary segment crossing criteria further includes that the mobile computing device is currently located in the area defined by the geofence boundary.

Example 70 may include the subject matter of any of Examples 68, and may further specify that the predetermined segment of the geofence boundary corresponds to a geographic location of an entryway.

Example 71 may include the subject matter of any of Examples 68, and may further specify that the content identifier includes a website address.

Example 72 may include the subject matter of any of Examples 68, and may further specify that the storage device has one or more memory structures to store the geofence boundary and to store the predetermined segment of the geofence boundary in association with the content identifier.

Example 73 may include the subject matter of any of Examples 68-72, further including: means for determining whether the mobile computing device satisfies second boundary segment crossing criteria; means for storing a result of the further determination in the storage device; and means for notifying the content access logic of the result of the further determination. The second boundary segment crossing criteria includes that the mobile computing device crossed a second predetermined segment of the geofence boundary into the area defined by the geofence boundary, the second predetermined segment of the geofence boundary is different from and non-overlapping with the predetermined segment of the geofence boundary, and the content access logic is to, in response to a determination that the mobile computing device satisfied the second boundary segment crossing criteria, provide a second content identifier associated with the second predetermined segment of the geofence boundary to the mobile computing device, wherein the second content identifier is different from the content identifier.

Example 74 may include the subject matter of any of Examples 68-72, further including means for accessing a location of the mobile computing device.

Example 75 may include the subject matter of any of Examples 68-72, further including means for accessing a trajectory traveled by the mobile computing device.

Example 76 may include the subject matter of any of Examples 68-72, and may further specify that the computing system is a same computing device as the mobile computing device.

Example 77 is an apparatus for regulating access to content, including: means for receiving a result of a determination of whether a mobile computing device satisfies boundary segment crossing criteria; and means for providing, in response to receiving a result that the mobile computing device satisfies the boundary segment crossing criteria, a content identifier, stored in a storage device and associated with the predetermined segment of the geofence boundary, to the mobile computing device. The boundary segment crossing criteria includes that the mobile computing device crossed a predetermined segment of a geofence boundary into an area defined by the geofence boundary, and the predetermined segment of the geofence boundary represents less than an entirety of the geofence boundary.

Example 78 may include the subject matter of Example 77, and may further specify that the content identifier includes a credential for provision, by the mobile computing device, to a server for access to content.

Example 79 may include the subject matter of any of Examples 77-78, and may further specify that the content identifier includes an image.

Example 80 is one or more computer readable media having instructions thereon that, in response to execution by one or more processing devices of a computing system, cause the computing system to perform the method of any one of Examples 22-32 and 56-67.

Example 81 is an apparatus including means for performing the method of any one of Examples 22-32 and 56-67.

What is claimed is:

1. One or more non-transitory computer readable media having instructions thereon that, in response to execution by one or more processing devices of a computing system, cause the computing system to:
determine whether a mobile computing device satisfies boundary segment crossing criteria, wherein the boundary segment crossing criteria includes that the mobile computing device crossed a predetermined segment of a geofence boundary into an area defined by the geofence boundary, wherein the predetermined segment of the geofence boundary represents less than an entirety of the geofence boundary; and
in response to a determination that the mobile computing device satisfied the boundary segment crossing criteria, provide a content identifier, associated with the predetermined segment of the geofence boundary, to the mobile computing device.

2. The one or more non-transitory computer readable media of claim 1, wherein the boundary segment crossing criteria further includes that the mobile computing device is currently located in the area defined by the geofence boundary.

3. The one or more non-transitory computer readable media of claim 1, wherein the predetermined segment of the geofence boundary corresponds to a geographic location of an entryway.

4. The one or more non-transitory computer readable media of claim 1, wherein the content identifier comprises a website address.

5. The one or more non-transitory computer readable media of claim 1, wherein the content identifier comprises a credential for provision, by the mobile computing device, to a server for access to content.

6. The one or more non-transitory computer readable media of claim 1, wherein the content identifier comprises an image.

7. The one or more non-transitory computer readable media of claim 1, further having instructions thereon that, in response to execution by the one or more processing devices of the computing system, cause the computing system to:
determine whether the mobile computing device satisfies second boundary segment crossing criteria, wherein the second boundary segment crossing criteria includes that the mobile computing device crossed a second predetermined segment of the geofence boundary into the area defined by the geofence boundary, and wherein the second predetermined segment of the geofence boundary is different from and non-overlapping with the predetermined segment of the geofence boundary; and
in response to a determination that the mobile computing device satisfied the second boundary segment crossing criteria, provide a second content identifier associated with the second predetermined segment of the geofence boundary to the mobile computing device, wherein the second content identifier is different from the content identifier.

8. The one or more non-transitory computer readable media of claim 1, further having instructions thereon that, in response to execution by the one or more processing devices of the computing system, cause the computing system to:
access a location of the mobile computing device.

9. A computing system for regulating access to content, comprising:
a storage device; and
boundary segment crossing logic, coupled to the storage device, to determine whether a mobile computing device satisfies boundary segment crossing criteria, store a result of the determination in the storage device, and notify a content access logic of the result of the determination;
wherein:
the boundary segment crossing criteria includes that the mobile computing device crossed a predetermined segment of a geofence boundary into an area defined by the geofence boundary,
the predetermined segment of the geofence boundary represents less than an entirety of the geofence boundary, and
the content access logic is to, in response to a determination by the boundary segment crossing logic that the mobile computing device satisfied the boundary segment crossing criteria, provide a content identifier, associated with the predetermined segment of the geofence boundary, to the mobile computing device.

10. The computing system of claim 9, wherein the boundary segment crossing criteria further includes that the mobile computing device is currently located in the area defined by the geofence boundary.

11. The computing system of claim 9, wherein the predetermined segment of the geofence boundary corresponds to a geographic location of an entryway.

12. The computing system of claim 9, wherein the content identifier comprises a website address.

13. The computing system of claim 9, wherein the storage device has one or more memory structures to store the geofence boundary and to store the predetermined segment of the geofence boundary in association with the content identifier.

14. The computing system of claim 9, wherein:
the boundary segment crossing logic is to further determine whether the mobile computing device satisfies second boundary segment crossing criteria, store a result of the further determination in the storage device, and notify the content access logic of the result of the further determination;
the second boundary segment crossing criteria includes that the mobile computing device crossed a second predetermined segment of the geofence boundary into the area defined by the geofence boundary;
the second predetermined segment of the geofence boundary is different from and non-overlapping with the predetermined segment of the geofence boundary, and
the content access logic is to, in response to a determination that the mobile computing device satisfied the second boundary segment crossing criteria, provide a second content identifier associated with the second predetermined segment of the geofence boundary to the mobile computing device, wherein the second content identifier is different from the content identifier.

15. The computing system of claim 9, further comprising:
location logic, coupled to the boundary segment crossing logic, to provide a location of the mobile computing device to the boundary segment crossing logic.

16. The computing system of claim 9, further comprising:
trajectory logic, coupled to the boundary segment crossing logic, to provide a trajectory traveled by the mobile computing device to the boundary segment crossing logic.

17. The computing system of claim 9, wherein the computing system is a same computing device as the mobile computing device.

18. The computing system of claim 9, further comprising the content access logic.

19. A computing system for regulating access to content, comprising:
a storage device; and
content access logic, coupled to the storage device, to receive a result of a determination of whether a mobile computing device satisfies boundary segment crossing criteria, and in response to receiving a result that the mobile computing device satisfies the boundary segment crossing criteria, provide a content identifier, stored in the storage device and associated with the predetermined segment of the geofence boundary, to the mobile computing device;
wherein the boundary segment crossing criteria includes that the mobile computing device crossed a predetermined segment of a geofence boundary into an area defined by the geofence boundary; and
wherein the predetermined segment of the geofence boundary represents less than an entirety of the geofence boundary.

20. The computing system of claim 19, wherein the content identifier comprises a credential for provision, by the mobile computing device, to a server for access to content.

21. The computing system of claim 19, wherein the content identifier comprises an image.

22. A method for regulating access to content, comprising:
determining, by a computing system, whether a mobile computing device satisfies boundary segment crossing criteria, wherein the boundary segment crossing criteria includes that the mobile computing device crossed a predetermined segment of a geofence boundary into an area defined by the geofence boundary, wherein the predetermined segment of the geofence boundary represents less than an entirety of the geofence boundary; and
in response to determining that the mobile computing device satisfies the boundary segment crossing criteria, providing, by the computing system, a content identifier, associated with the predetermined segment of the geofence boundary, to the mobile computing device.

23. The method of claim 22, wherein the boundary segment crossing criteria further includes that the mobile computing device is currently located in the area defined by the geofence boundary.

24. The method of claim 22, wherein the content identifier comprises a credential for provision, by the mobile computing device, to a server for access to content.

25. The method of claim 22, wherein the content identifier enables access to multimedia content.
